(19) United States
(12) Patent Application Publication
(10) Pub. No.: US 2005/0274757 A1
(43) Pub. Date: Dec. 15, 2005

(54) Vehicular rail mounting system

(76) Inventor: John M. Arend, Belmont, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/855,166

(22) Filed: May 27, 2004

(51) Int. Cl. B60R 7/00; B60R 9/00

(52) U.S. Cl. 224/403

(57) ABSTRACT

A mounting system for a vehicle rail including a bracket and a lock member. The bracket and lock member are individually slidable along the rail and removable from the rail, but can be interfit such that they are both locked on the rail. The bracket interfits with a first lip on the channel, and the lock member interfits with the second lip and the bracket. The bracket and lock member are fit together so that they fill substantially all of the mouth of the channel and cannot be removed from the rail. The pieces can be configured as desired to accommodate the mounting of a wide variety of accessories.

### BACKGROUND OF THE INVENTION

The present invention relates to the attachment of components to a vehicle rail system, and more particularly to an assembly for securely mounting components on the rail system.

Rail systems are well known for attaching accessories to vehicles. In many cases, elongated rails are disposed along opposite sides of a vehicle rooftop, and are used to mount accessories such as luggage racks, ski racks and bike racks to the roof of the vehicle. The rails commonly include a channel or groove that attaches over the body of the vehicle, or extends down into the body of the vehicle. A variety of fasteners are known for attaching accessories to the rail, such as a nut that is secured inside the channel. The accessory attaches to the nut with a conventional fastener to secure both pieces to the rail.

Recently, vehicle manufacturers have begun installing vehicle rails in places other than rooftops, such as on opposite sides of a cargo bed. These new applications open the door to an array of new accessories and potential uses for vehicle rails, and consequently require new mounting systems that are widely adaptable, easy to use, and yet more durable and reliable than existing mounting systems.

### SUMMARY OF THE INVENTION

The aforementioned problems are overcome by the present invention, wherein a mounting system for a vehicle rail includes multiple pieces that are individually slidable along the rail and removable from the rail, but can be interfit such that they are both locked on the rail. The pieces can be configured as desired to accommodate a wide variety of accessories.

As disclosed, the present invention includes a bracket and a lock member that fit onto a rail that includes a channel portion with a mouth having first and second lips. The bracket interfits with the first lip, and the lock member interfits with the second lip. When the bracket and lock member are fit together, they fill substantially all of the mouth so that each piece is retained on a respective lip and on the other piece, and neither can be removed from the rail.

As more specifically disclosed, the bracket includes two flanges. The first flange interfits with a first lip on the rail. The second flange interfits with a ledge on the lock member. A portion of the bracket and the lock member overlap, so that the two pieces can be attached together. The lock member can be clamped to the rail to secure the lock member and the bracket in a fixed position on the rail.

The bracket and the lock member can be arranged in wide variety of shapes and sizes to accommodate a desired accessory. They are easy to install and remove, yet once installed they are securely locked on the rail.

These and other objects, advantages, and features of the invention will be more fully understood and appreciated by reference to the description of the current embodiment and the drawings.

### BRIEF DESCRIPTION OF THE DRAWINGS

FIG. 1 is a perspective view of a truck bed with rails and a mounting assembly in accordance with the present invention.

FIG. 2 is a close up view of the truck bed and mounting assembly.

FIG. 3 is an exploded view of a rail and a bracket.

FIG. 4 is a perspective view of a rail and a bracket.

FIG. 5 is a side view of a rail and a bracket before insertion onto the rail.

FIG. 6 is a side view of a rail and a bracket on the rail.

FIG. 7 is a side view of a rail and a bracket interfitted with the rail.

FIG. 8 is an exploded view of the lock member.

FIG. 9 is a side view of the lock member.

FIG. 10 is a perspective view of a bracket interfitted with the rail and a lock member above the rail.

FIG. 11 is a side view of a bracket interfitted with the rail and a lock member above the rail.

FIG. 12 is a perspective view of a bracket interfitted with the rail and a lock member interfitted with the rail.

FIG. 13 is a perspective view of the bracket and lock member interfitted together on the rail with a fastener above the rail.

FIG. 14 is a perspective view of the bracket and the lock member interfitted on the rail with a fastener inserted.

FIG. 15 is a cross sectional view of the bracket and lock member interfitted on the rail.

### DESCRIPTION OF THE CURRENT EMBODIMENT

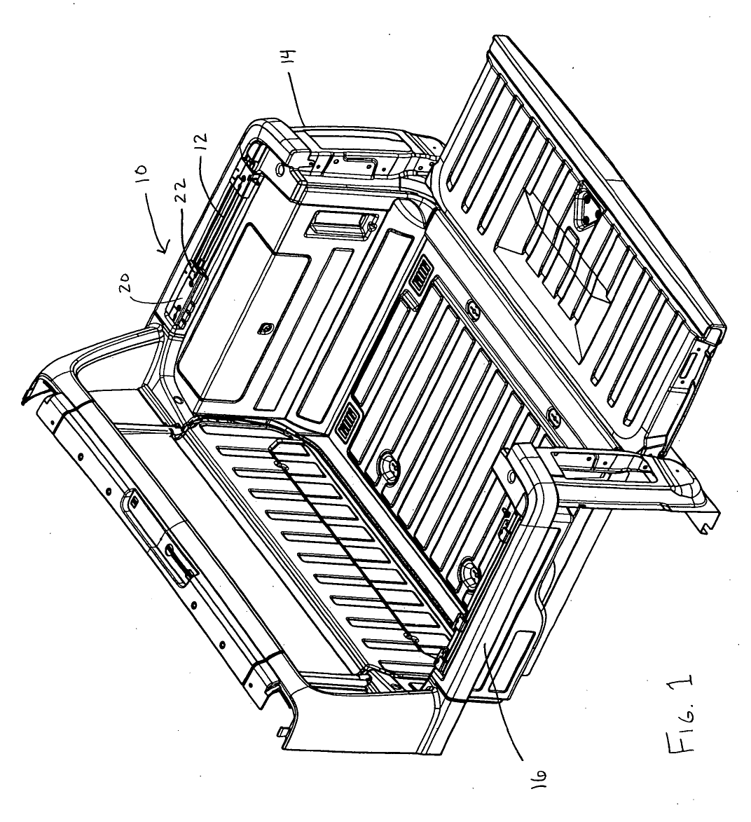

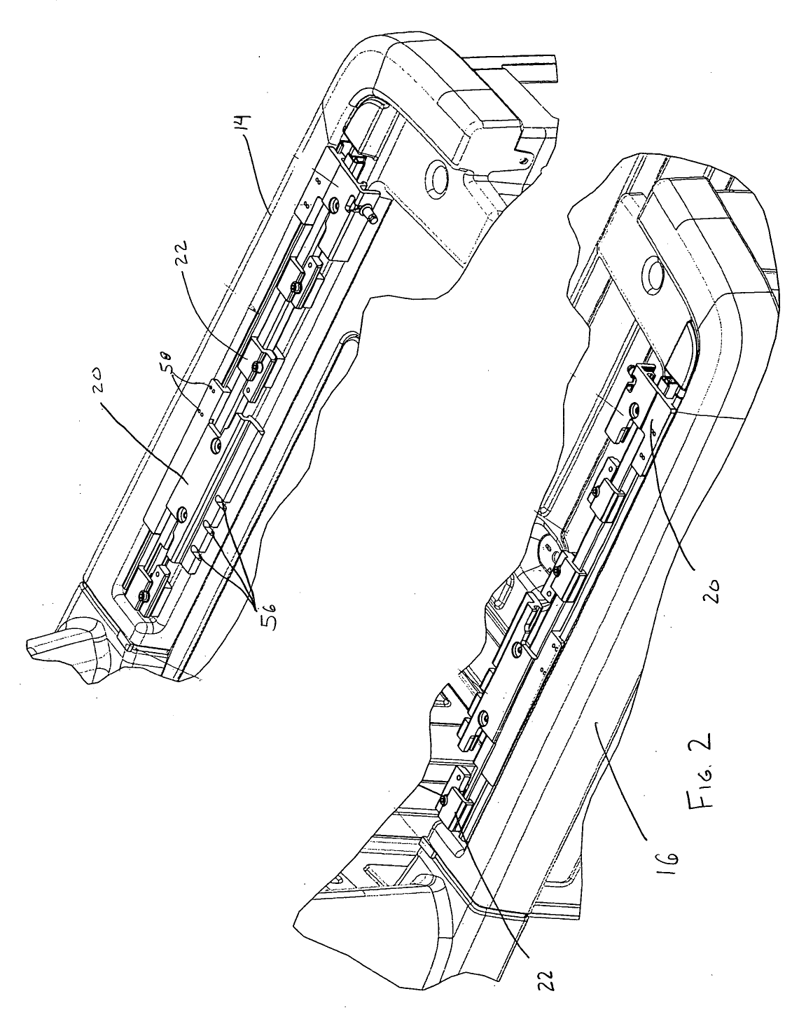

A mounting assembly in accordance with the present invention is shown in FIG. 1 and is generally designated 10. As shown in FIG. 1, a plurality of mounting assemblies 10 are disposed on rails 12. The rails are affixed to opposite side walls 14, 16 of a pickup truck bed. The mounting assembly 10 generally includes a bracket 20 and a lock member 22 interfitted on a rail 12. Both the bracket 20 and the lock member 22 are independently slidable and removable from the rail 12, but when fit together they are locked on the rail 12.

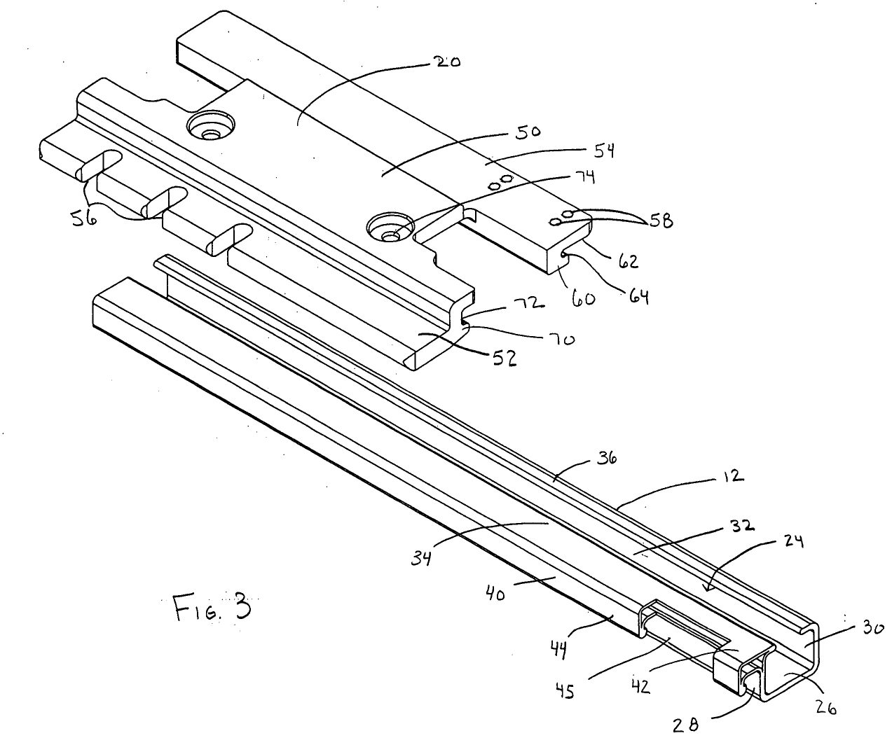

The rail (or rails) 12 are generally affixed to a vehicle in a well known manner. The rail 12 may be embedded into the body of the vehicle, or may be attached over the surface of the vehicle. While they are shown affixed to the opposite sidewalls 14, 16 of a pickup truck box, it should be noted that they may be disposed in a wide variety of locations on a variety of vehicles. The rail 12 is typically roll formed or otherwise formed from a metal, such as steel or aluminum, or from plastic. As shown in FIG. 3, the rail includes a channel 24 including a planar bottom wall 26 and a pair of upstanding side walls 28 and 30. The side walls 28 and 30 extend upward from the bottom wall to define a mouth 32, and turn inward to form a pair of lips 34 and 36 on either side of the mouth 32. In the disclosed embodiment, the lips 34, 36 both turn inward so that the mouth 32 is partially closed, however, one or both of the lips 34, 36 may alternatively turn outward and may be placed at a different location on the side walls 28 and 30. As shown in FIG. 3, the rail additionally includes an outer flange 40. The flange 40 includes a first member 42 that extends outwardly from one of the lips 34, and a second member 44 extending downwardly at an angle from the first member 42. The flange 40 is common to many rail structures, but is not necessary and may take a variety of different forms depending on the manufacturer and the desired application. Also in FIG. 3, the rail may include one or more cutouts 45, the cutouts generally extend through both members 42 and 44 of the outer flange 40.

The bracket 20 is commonly extruded from aluminum or another suitable material, but may be formed from other suitable methods. As disclosed, the bracket 20 includes a central portion 50, and opposing lateral portions 52 and 54 on either side of the central portion 50. The lateral portions 52 and 54 generally include one or more means for attaching a desired accessory, such as slots 56 shown on lateral portion 52 and mounting holes 58 shown on the lateral portion 54. A first flange 60, or rail flange, is located on one of the lateral portions 52, 54. As shown, the rail flange 60 extends from the bottom edge 62 of lateral portion 54. The rail flange 60 forms a channel 64 that can interfit with one of the lips 32, 34 of the rail 12. A second flange 70, or lock flange, is located on the opposite lateral portion 52 or the central portion 50. The lock flange 70 forms a channel 72 that can interfit with a portion of the lock member 22 as described below. The bracket 20 additionally includes a hole 74 extending through the bracket 20 for receiving a conventional fastener, and a cutout 76 in the central portion 50. The cutout 76 is shaped to receive the body of the lock member 22 when the bracket 20 and the lock member 22 are fit together.

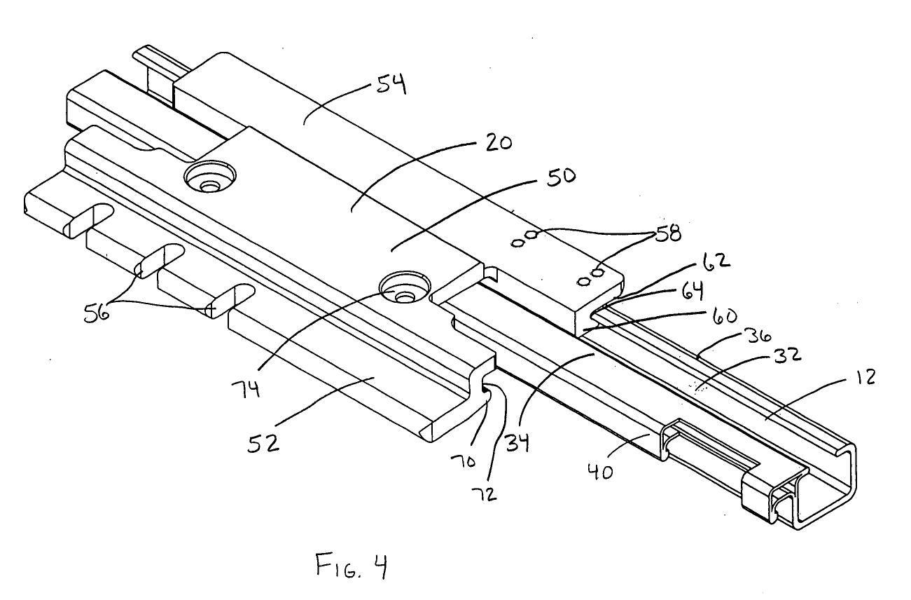

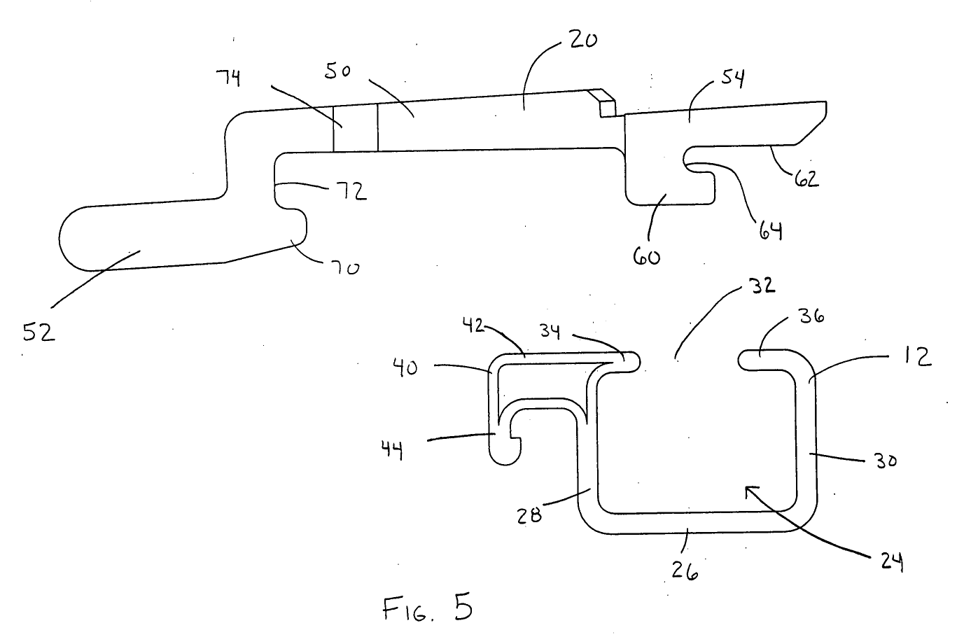

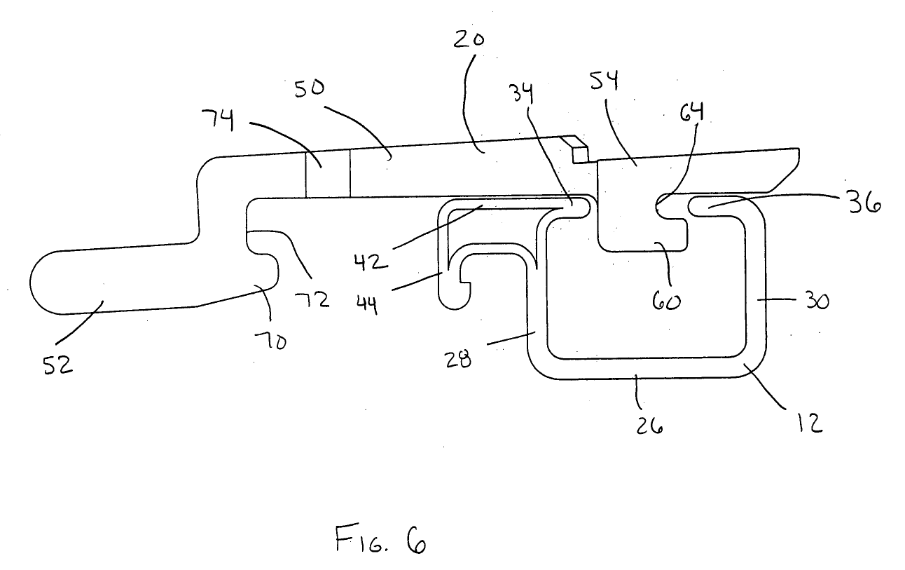

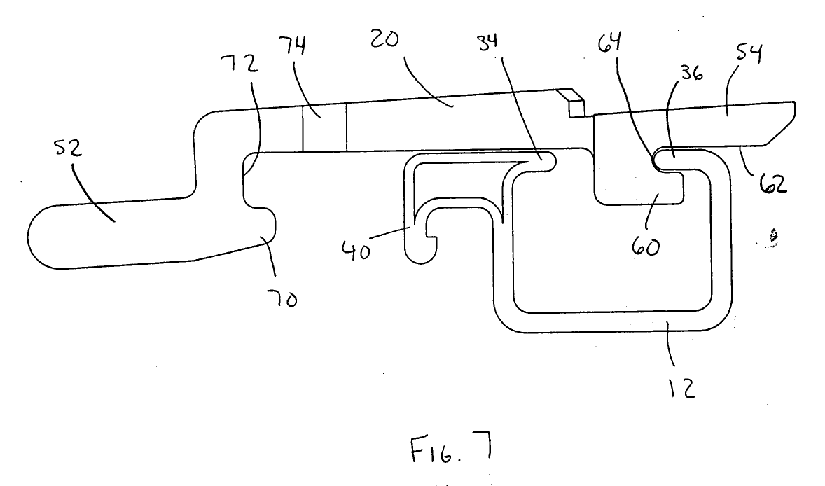

As shown in FIGS. 4-7 the bracket 20 interfits with the rail 12 such that it is slidable along the rail 12 and removable from the rail 12. The bracket 20 is held over the rail 12 (FIG. 5) with the rail flange 60 over the mouth 32, then set down on the rail 12 (FIG. 6) with the rail flange 60 extending through the mouth 32, and finally pushed forward (FIG. 7) so that the lip 36 of the rail 12 fits into the opening 64 formed by the rail flange 60. When interfitted with the rail 12, the lateral portion 52 extends past the opposite side of the rail 12. Because nothing is holding the flange 60 against the lip 36, the bracket 20 can be easily removed from the rail 12 and positioned on the rail 12.

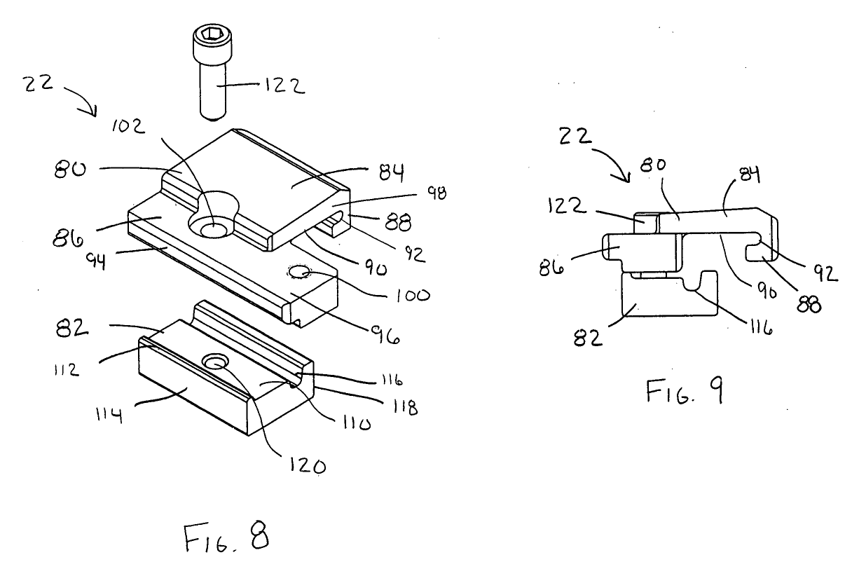

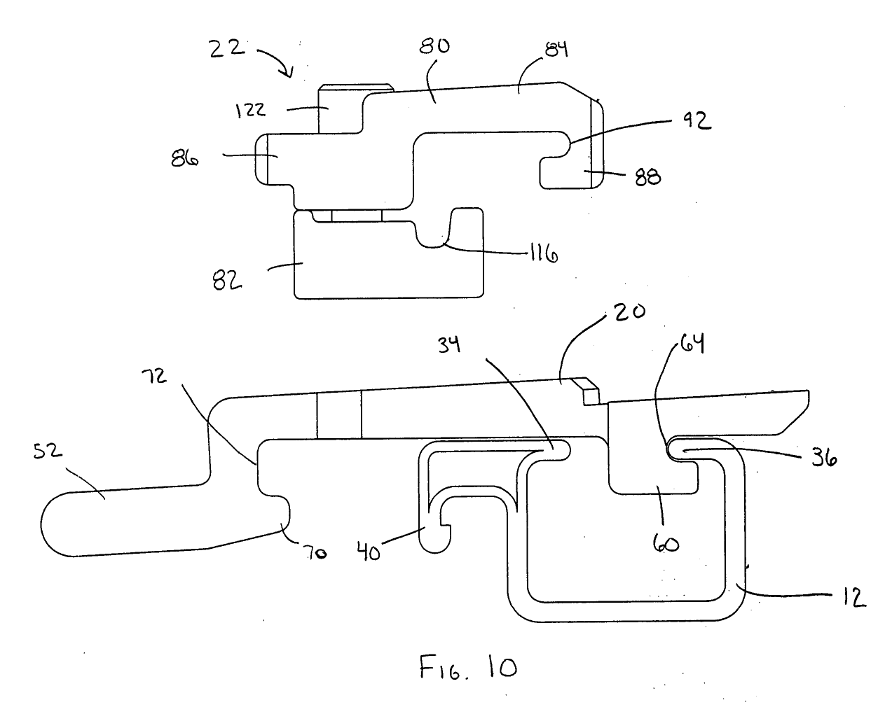

As shown in FIGS. 8 and 9, the lock member 22 is generally comprised of an upper component 80 and a lower component 82. Both components are formed of similar materials and by similar methods as the bracket 20. The upper component 80 includes a flange portion 84 and a tab portion 86. The flange portion 84 includes a flange 88 that extends downwardly from the lower surface 90 of the flange portion 84. The flange 88 forms a channel 92 that is shaped to fit over the second rail lip 34. The tab portion 86 includes a ledge 94 opposite the flange portion 84 that is sized to fit with the opening 72 of the lock flange 70. The tab portion 86 further includes a tab 96 that extends past an outer edge 98 of the flange portion 84 below the lower edge 90 of the flange portion 84. The tab includes first and second holes 100 and 102 for receiving conventional fasteners. The hole 100 is positioned to align with the hole 74 of the bracket 20 to receive a fastener 130 when the lock member 22 and bracket 20 are interfitted as described below. The lower component 82 includes an upper surface 110 having an upstanding rib 112 on a first edge 114, and a groove 116 near the opposite edge 118. A hole 120 extends through the lower component 82 such that the upper component 80 and the lower component 82 can be joined by a fastener 122 that extends through the second hole 102 on the upper component 80 and the hole 120 on the lower component 82.

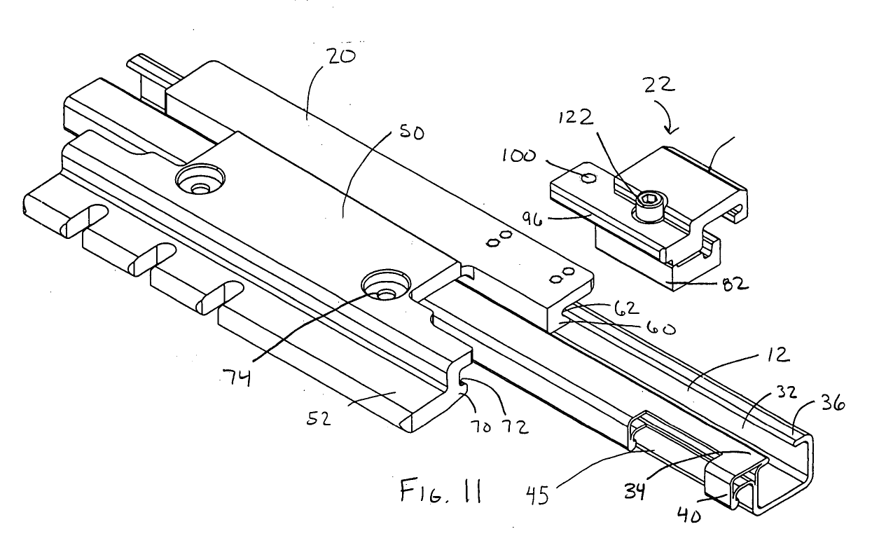

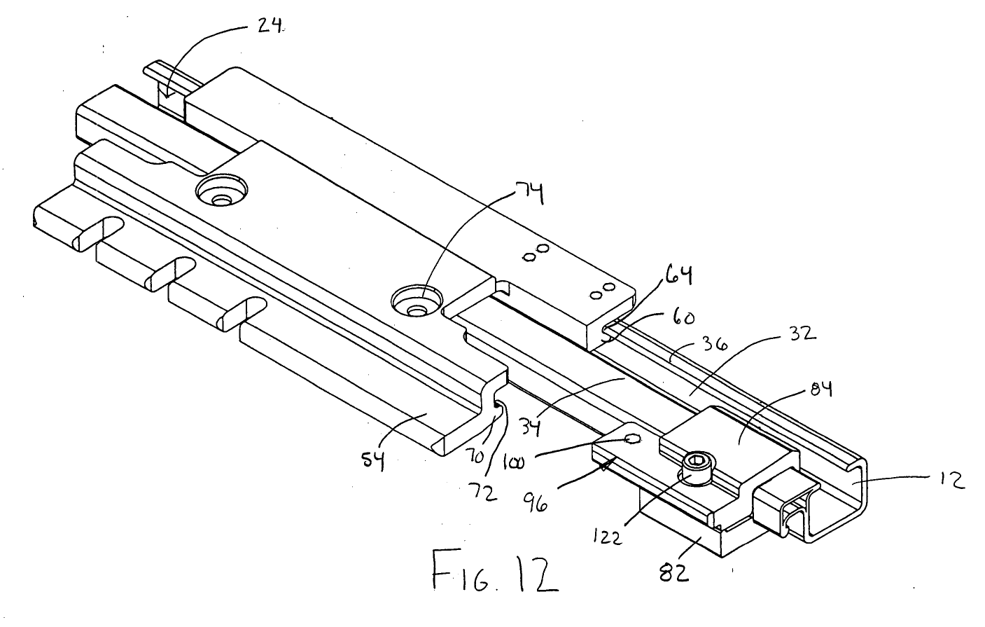

As shown in FIGS. 10-12, the lock member 22 interfits with the rail 12 such that it is slidable with the rail 12 and removable from the rail 12. The lock member 22 may be disposed on the rail in a variety of ways, for instance, the upper 80 and lower 82 components together may be inserted into a cutout 45 on the rail 12 and then slide along the rail 12. The upper 80 and lower 82 components may also be separated by fastener 122, placed on opposite sides of the outer flange 40, and then re-fastened with the fastener 122. The upper component 80 fits on the rail 12 such that the opening 92 of the flange 88 fits onto the second lip 34 of the rail 12. The lower component 82 is placed under the outer flange 40 such that the channel 116 fits onto the second member 44 of the outer flange 40. The fastener 122 may be tightened to clamp the upper 80 and lower 82 components together about the flange 40, thereby securing the lock member 22 in a fixed position on the rail 12. The lock member 22 is generally positioned on the rail 12 so that the tab 96 faces the bracket 20. As noted above, some rails do not include outer flange 40. In these situations, the lock member 22 may be alternatively configured. For instance, the lower component 82 could be eliminated and a portion of the upper component 80 including a set screw could extend around the outside of the channel 24, using the set screw to clamp the lock member 22 on the rail. Various other locking methods could be used.

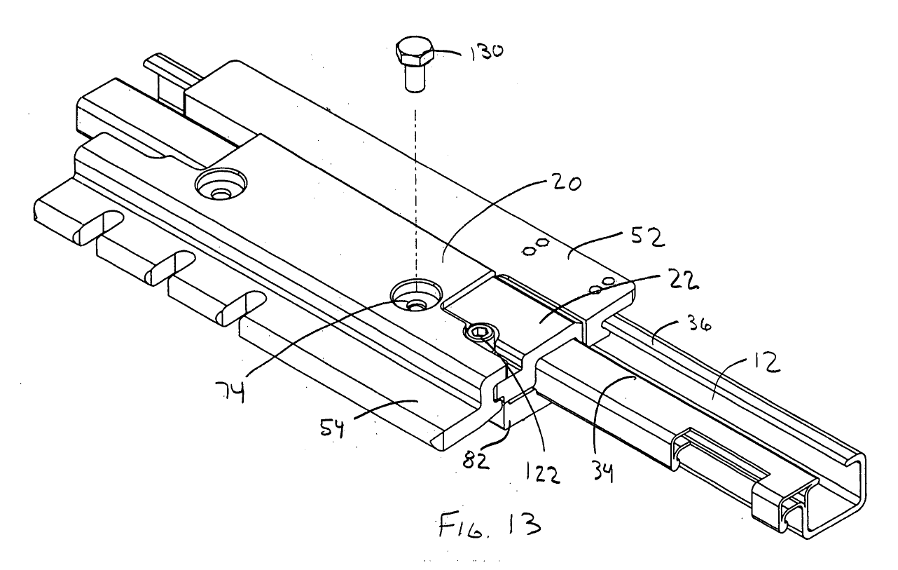

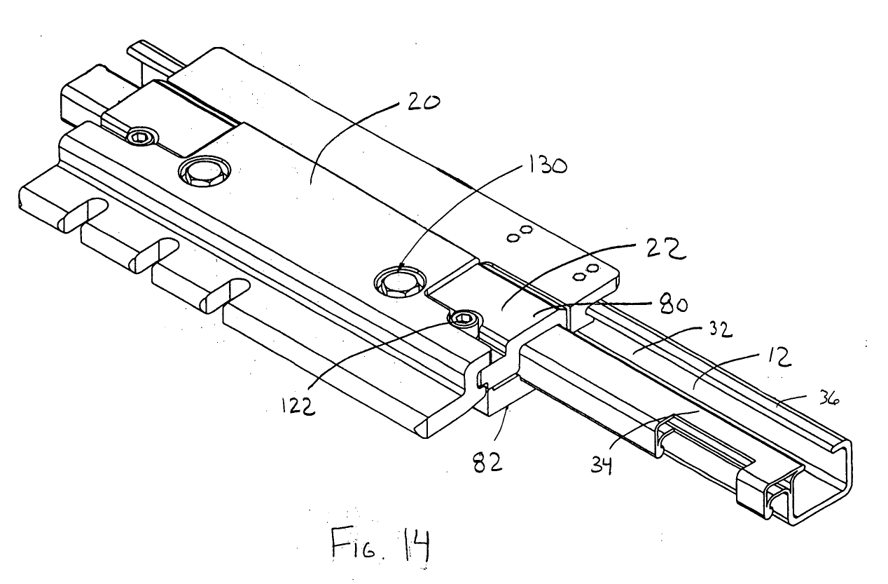

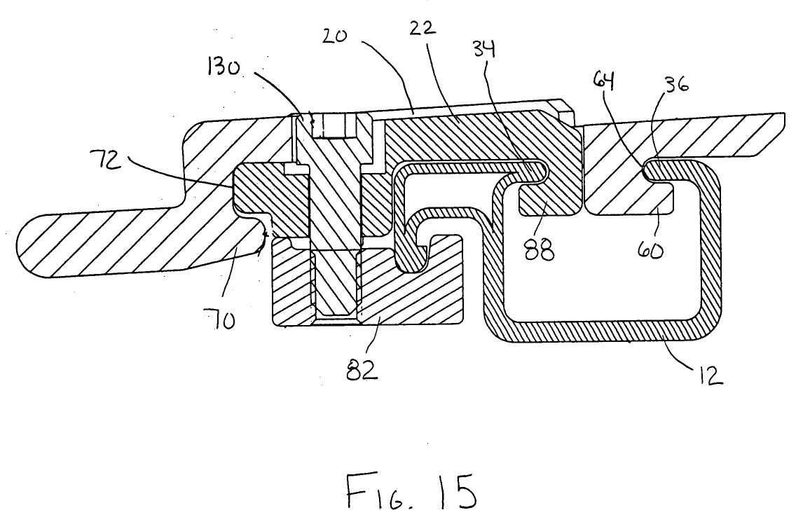

As shown in FIGS. 12-15, the bracket 20 and lock member 22 can be interfitted together so that both are locked on the rail 12. First, both the bracket 20 and lock member are individually placed on the rail 12 as described above. Since both pieces are slidable along the rail 12, they can be brought together so that the first lateral portion 54 of the bracket 20 and the flange portion 84 of the lock member 22 combine to substantially fill the mouth 32 of the channel 24. This retains the rail flange 60 on the first channel lip 36, and retains the flange 88 of the lock member 22 on the second channel lip 34, thus preventing the removal of either piece from the rail 12. In addition, the ledge 94 of the lock member 22 fits into the lock flange 70 of the bracket to increasingly secure the bracket 20 and lock member 22 to the rail 12. In some cases, such as the disclosed embodiment including both an upper 80 and lower 82 component of the lock member 22, this additional engagement allows for elimination of the flange 88 on the lock member 22 as the pieces would still be retained on the rail 12. The tab 96 of the lock member 22 fits underneath a portion of the bracket 20 so that the holes 74 and 100 are aligned. Once the bracket 20 and lock member are interfitted, the fastener 130 (FIG. 13), can be inserted through the holes 100 and 72 to prevent the bracket 20 and the lock member 22 from sliding apart. Of course, other conventional means of attaching the two pieces together would suffice. The fastener 122 can be tightened at any time to clamp the upper portion 80 and the lower portion 82 of the lock member 22 to fix the position of the pieces on the rail. Alternatively, the position could also be fixed by other methods to accommodate for different rail types or different accessories as mentioned above. Any desired component can be secured to holes 58, slots 56, or other attachment device. Depending on the desired mounting arrangement and accessories, the bracket 20 may be configured to receive two lock members 22, one at each end.

The above description is that of a current embodiment of the invention. Various alterations and changes can be made without departing from the spirit and broader aspects of the invention, which are to be interpreted in accordance with the principles of patent law including the Doctrine of Equivalents.

1. A rail mounting system for a vehicle defining a channel having first and second lips defining a mouth, said system comprising:
a bracket including a rail flange and a lock flange, said rail flange adapted to interfit with said first lip such that said bracket is slidable along said first lip and removable from said channel; and
a lock member, said lock member interfitting with said second lip and said lock flange to prevent removal of said bracket from said channel.

2. The rail mounting system of claim 1 wherein said lock member includes a flange that interfits with said second lip.

3. The rail mounting system of claim 1 wherein said lock member includes a clamp for securing said lock in a fixed position on said channel.

4. The rail mounting system of claim 3 wherein said lock member includes a first clamp component and a second clamp component, said first and second clamp components joined together to secure said lock member in a secured position on the channel.

5. The rail mounting system of claim 4 wherein said first clamp component and said second clamp component are joined by a fastener that extends through corresponding holes in said first and second clamp components.

6. The rail mounting system of claim 1 wherein a portion of said bracket overlaps a portion of said lock member and is attachable to said portion of said lock member.

7. The rail mounting system of claim 5 wherein said portion of said bracket and said portion of said lock member are attachable by a fastener that extends through said portion of said lock member and said portion of said bracket.

8. The rail mounting system of claim 1 wherein said bracket includes a perimeter edge defining a recess, said lock member including a perimeter edge fitting substantially within said recess.

9. A mounting system for a channel on a vehicle, the channel having a mouth with first and second lateral edges, the mounting system comprising:
a lock member interfitting with a first edge of the channel, said lock member having a clamp for securing the lock member in a fixed position along said channel; and
a bracket including a rail flange and a lock flange, said rail flange interlocking with the second lateral edge, said lock flange interlocking with the lock member to secure said bracket and said lock member on the channel in said fixed position.

10. The mounting system of claim 9 wherein said locking member includes a first flange that interlocks with the second edge of the channel mouth.

11. The mounting system of claim 9 wherein said bracket includes a first portion including said rail flange that interlocks with the first lateral edge, and a second portion including said lock flange that extends past the second lateral edge.

12. The mounting system of claim 9 wherein a portion of said bracket overlaps a portion of said lock member, said portion of said bracket attachable to said portion of said lock member.

13. The mounting system of claim 12 wherein said portion of said bracket and said portion of said lock member are attached by a fastener that extends through said portion of said bracket and said portion of said lock member.

14. The mounting system of claim 9 wherein said lock member is secured in a fixed position on said channel by a clamp on said lock member.

15. The mounting system of claim 14 wherein said lock member includes a first clamp component and a second clamp component, said first and second clamp components joined together to secure said lock member in a fixed position on said channel.

16. A mounting system for a vehicle comprising:
a rail including a channel, said channel having a mouth and first and second lips;
a bracket interfitting with said first lip;
a lock member interfitting with said second lip and said bracket, said lock member and said bracket interfitting to fill substantially all of said mouth such that said bracket and said lock member cannot be removed from said rail.

17. The mounting system of claim 16 wherein said lock member includes a clamp for securing said lock member in a fixed position on said channel, such that said lock member and said bracket are secured in a fixed position on said channel when said bracket and said lock member are fit together.

18. The mounting system of claim 17 wherein said lock member includes a first clamp member and a second clamp member, said first and second clamp members joined together to secured said lock member in a fixed position on said channel.

19. The mounting system of claim 18 wherein said first clamp member and said second clamp member are joined together by a fastener.

20. The mounting system of claim 19, said rail including a second channel distinct from said first channel, said first and second clamp members joined on opposite sides of said second channel.

21. The mounting system of claim 16 wherein said bracket includes a rail flange interfitting with said first lip and a lock flange interfitting with said lock member.

22. The mounting system of claim 16 wherein a portion of said bracket overlaps a portion of said lock member and is attachable to said portion of said lock member.

23. The mounting system of claim 22 wherein said portion of said bracket and said portion of said lock member are attached by a fastener that extends through said portion of said bracket and said portion of said lock member.

24. The mounting system of claim 23 wherein said bracket includes a perimeter edge defining a recess, said lock member including a perimeter edge fitting substantially within said recess.
